(19) United States
(12) Patent Application Publication
(10) Pub. No.: US 2017/0010798 A1
(43) Pub. Date: Jan. 12, 2017

(54) MANIPULATION SYSTEM

(71) Applicant: DENSO CORPORATION, Kariya-city, Aichi-pref. (JP)

(72) Inventor: Chihiro HIRANO, Kariya-city (JP)

(73) Assignee: Denso Corporation, Aichi (JP)

(21) Appl. No.: 15/120,536

(22) PCT Filed: Feb. 6, 2015
(86) PCT No.: PCT/JP2015/000554

§ 371 Date: Aug. 22, 2016

(30) Foreign Application Priority Data
Feb. 27, 2014 (JP) 2014-036680

(51) Int. Cl. G06F 3/0488; G06F 3/0485; G06F 3/0484; G06F 3/0481; G06F 3/0482

(52) U.S. Cl. CPC G06F 3/04883; G06F 3/04817; G06F 3/0482; G06F 3/04845; G06F 3/0485

(57) ABSTRACT

A manipulation system includes (i) a main unit with a display apparatus to be manipulated, and (ii) a remote manipulation apparatus that manipulates an input to the display apparatus. The remote manipulation apparatus includes (i) a flat touch manipulation portion and (ii) a signal output unit that detects a manipulation position and outputs a manipulation position signal by detecting a user manipulation including touch-on and touch-off on the touch manipulation portion using a finger or a touch pen. The main unit includes a manipulation determination section that determines a user manipulation based on a manipulation position signal notified from the signal output unit of the remote manipulation apparatus. The manipulation determination section determines either a flick manipulation or a tap manipulation based on a movement speed of a touch position from the touch-on to the touch-off on the touch manipulation portion.

### CROSS REFERENCE TO RELATED APPLICATION

The present application is based on Japanese Patent Application No. 2014-036680 filed on Feb. 27, 2014, the disclosure of which is incorporated herein by reference.

### TECHNICAL FIELD

The present disclosure relates to a manipulation system including: a main unit that includes a display apparatus and is manipulated; and a remote manipulation apparatus that manipulates an input to the display apparatus.

### BACKGROUND ART

An in-vehicle unit such as a navigation apparatus includes a liquid crystal display apparatus, which is provided at the center of an instrument panel to display a map screen image around the current vehicle position. The liquid crystal display apparatus has a screen that is provided with a touch panel. A user (driver) manually touches the touch panel or a mechanical switch provided near the screen to input various instructions to the navigation apparatus. The instructions include configuring route guidance setup such as destination setup, scrolling a map, or changing the map scale. The scale signifies the ratio of a distance on the map to the corresponding distance on the ground and can be expressed as (Distance on the map)/(Distance on the ground).

As proposed in patent literature 1, a touchpad is recently used in addition to the touch panel so that a user can remotely manipulate a display screen image in an in-vehicle navigation apparatus. In this case, the touchpad includes a planar touch manipulation portion though not specifically described in patent literature 1. The user traces the touch manipulation portion with the user's finger to move a cursor (pointer) to a targeted icon (manipulation button) on the screen of the display apparatus. In this state, the user taps the touch manipulation portion to select the icon.

### PRIOR ART LITERATURES

### Patent Literature

Patent Literature 1: JP 2012-221387 A

### SUMMARY OF INVENTION

Obviously, as above, the touchpad can be used as a remote manipulation apparatus for the in-vehicle unit such as the navigation apparatus to perform manipulation such as moving the cursor and clicking on a targeted icon. In addition, the touch manipulation portion enables various gesture manipulations such as a flick manipulation (to suddenly move a finger in a given direction while the finger remains in touch with a manipulation surface) to perform various functions such as scrolling the map as a display screen image or changing (reducing or enlarging) the map scale.

However, various gesture manipulations using the touchpad may cause inconvenience as follows. The cursor basically moves when one finger is used for movement manipulation on the touch manipulation portion of the touchpad. Even the user's flick manipulation also moves the cursor. An icon may be tapped if the position to lift the finger corresponds to the icon on the screen at the time of completing the flick manipulation on the touchpad. This may result in performing a manipulation the user did not intend.

It is an object of the present disclosure to provide a manipulation system that includes a remote manipulation apparatus having a touch manipulation portion and can reliably determine touch manipulation on the touch manipulation portion and prevent a process contrary to user's intention from being performed.

To achieve the object, according to an example of the present disclosure, a manipulation system is provided to include (i) a main unit with a display apparatus to be manipulated and (ii) a remote manipulation apparatus that manipulates an input to the display apparatus. The remote manipulation apparatus includes (i) a flat touch manipulation portion and (ii) a signal output unit that detects a manipulation position and outputs a manipulation position signal by detecting a user manipulation including touch-on and touch-off on the touch manipulation portion using either a finger or a touch pen. The main unit includes a manipulation determination section that determines a user manipulation based on a manipulation position signal notified from the signal output unit of the remote manipulation apparatus. The manipulation determination section determines either a flick manipulation or a tap manipulation based on a movement speed of a touch position in a period of time from the touch-on to the touch-off on the touch manipulation portion.

Suppose that the user manipulates the touch manipulation portion using user's one finger. First, the tap manipulation, where the user taps an icon on the screen without moving the finger, causes very little or no change between the touch-on position and the touch-off position. Second, the moving manipulation, where the user moves the cursor on the screen by moving the finger from the touch-on position to the touch-off position, causes the movement speed of the finger (touch position) to be relatively low. Third, contrastingly, the flick manipulation, where the user relatively fast moves the finger after the touch-on, causes the touch-off manipulation to occur in a short period of time.

The above-mentioned configuration includes a remote manipulation apparatus with a touch manipulation portion and can reliably determine touch manipulation on the touch manipulation portion and prevent a process contrary to user's intention from being performed.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an embodiment of the disclosure and schematically illustrating an external configuration of a manipulation system;

FIG. 2 is a block diagram schematically illustrating an electrical configuration of the manipulation system;

FIG. 3 is a flowchart illustrating a manipulation determination process in a controller; and

FIG. 4 is a diagram illustrating a map display screen image on a display apparatus.

### EMBODIMENTS FOR CARRYING OUT INVENTION

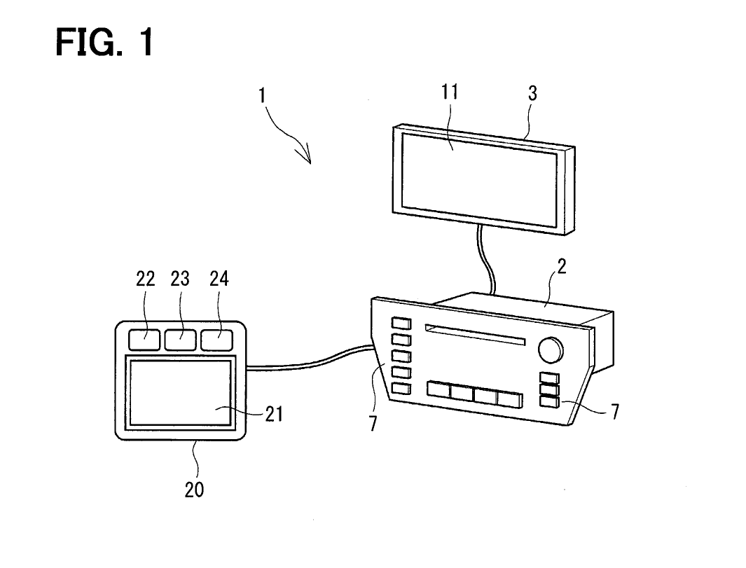

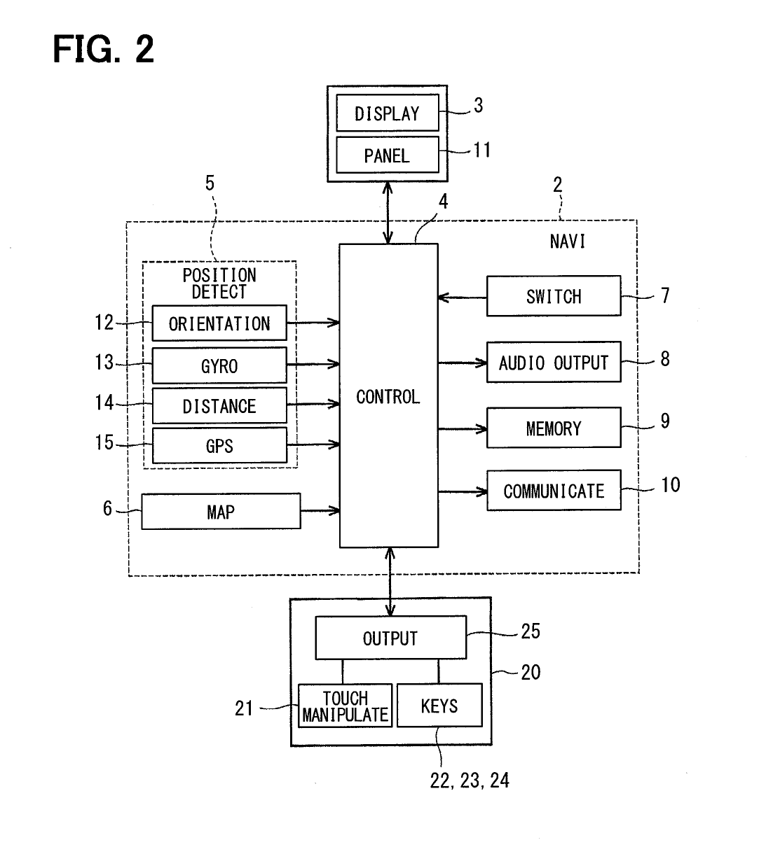

With reference to the accompanying drawings, the description below explains an embodiment of applying the present disclosure to a navigation apparatus that is mounted on a vehicle (automobile) and is assumed to be a manipulation target that is to be manipulated. The vehicle mounted with the navigation apparatus is also referred to as a host vehicle. FIG. 1 schematically illustrates an external configuration of a manipulation system 1 according to the embodiment. FIG. 2 illustrates an electrical configuration of the manipulation system 1. As in FIG. 1, the manipulation system 1 according to the embodiment includes a navigation apparatus body 2 (hereinafter also referred to as a navigation apparatus 2) as a main unit, a display apparatus 3, and a touchpad 20 as a remote manipulation apparatus. The display apparatus 3 and the touchpad 20 are connected to the navigation apparatus 2.

The navigation apparatus 2 is built into the center of an automobile's instrument panel though not illustrated in detail. The display apparatus 3 is provided over the center of the instrument panel. The touchpad 20 is portably provided within user's reach or at a position where a driver or other occupants can easily manipulate. The navigation apparatus (navigation apparatus 2) according to the embodiment is configured as an apparatus that includes a car audio function (video and music). However, the description below explains (illustrates) a navigation function only.

As in FIG. 2, the navigation apparatus 2 includes a controller 4 (also referred to as a control apparatus or a navigation ECU (Electronic Control Unit)). The navigation apparatus 2 also includes a position detector 5, a map database 6, a manipulation switch 7, an audio output apparatus 8, an external memory unit 9, and a communication apparatus 10 that are connected to the controller 4. A publicly known touch panel 11 is provided on the surface of the screen of the display apparatus 3. The controller 4 is mainly configured as a computer including a CPU, ROM, and RAM. The controller 4 controls the navigation apparatus 2 and the whole of the manipulation system 1 based on a program stored in the ROM.

The position detector 5 includes an orientation sensor 12, a gyro sensor 13, and a distance sensor 14, to estimate vehicle positions based on the autonomous navigation. The orientation sensor 12 detects the vehicle orientation. The gyro sensor 13 detects a turning angle of the vehicle. The distance sensor 14 detects a travel distance of the vehicle. The position detector 5 also includes a GPS receiver 15 that receives radio waves transmitted from an artificial satellite for GPS (Global Positioning System) in order to measure a vehicle position, based on the electrical navigation. The controller 4 detects the host vehicle's current position (absolute position), travel direction, speed, travel distance, and current time based on inputs from the sensors 12 through 15 included in the position detector 5.

The map database 6 stores, for instance, road map data about the whole of Japan and associated data including destination data such as facilities and shops, and map matching data. The map database 6 functions as a map data acquisition device or means. The road map data includes a road network that uses lines to represent roads on the map. The road map data is divided into several portions using intersections or branch points as nodes. The road map data is available as link data that defines a link between nodes. The link data contains a link-specific link ID (identifier), a link length, position data (longitude and latitude) for a start point or an end point (node) of a link, angle (direction) data, a road width, a road type, and a road attribute. The link data also contains data to reproduce (draw) the road map on a screen of the display apparatus 3.

The display apparatus 3 includes a liquid crystal display instrument capable of color display. A screen of the display apparatus 3 displays a menu screen image or a map screen image (see FIG. 4) when the navigation function is used. The controller 4 controls map display of the display apparatus 3 based on the host vehicle position detected by the position detector 5 and the map data in the map database 6. The display apparatus 3, the controller 4, and the map database 6 provide a map display function. The navigation apparatus 2 includes the map display function. The user is capable of various inputs and instructions by touching the touch panel 11 on the screen of the display apparatus 3. The audio output apparatus 8 includes a speaker and outputs music or guidance audio. The communication apparatus 10 exchanges data such as road information with an external information center.

The navigation apparatus 2 (controller 4) performs, as publicly known, a navigation process such as the location function to allow the screen of the display apparatus 3 to display a detected host vehicle position along with the road map or the route guidance function to search for an appropriate route to a user-specified destination for a guidance purpose. The route search uses the publicly known Dijkstra's algorithm. As publicly known, the route guidance uses the screen display on the display apparatus 3 and necessary guidance audio output from the audio output apparatus 8.

FIG. 4 illustrates an example of displaying a navigation screen image (map display screen image) on the display apparatus 3. The example displays a current position and a travel direction of the host vehicle in overlap with a road map screen image. The route guidance function in process displays a recommended route to be traveled for a guidance purpose. The screen of the display apparatus 3 displays cursor C (pointer) and several icons I (manipulation buttons) to activate various functions.

As in FIG. 1, the touchpad 20 as a remote manipulation apparatus according to the embodiment is shaped like a square flat panel as a whole. The surface (top face) thereof includes a touch manipulation portion 21 (also referred to as a touch panel). The touchpad 20 according to the embodiment horizontally includes three manipulation keys 22, 23, and 24. The three manipulation keys 22, 23, and 24, in sequence from the left, function as the manipulation key 22 for “display map,” the manipulation key 23 for “return,” and the manipulation key 24 for “submit.”

The touch manipulation portion 21 is, as publicly known, configured as a matrix of electrodes in the X-axis and Y-axis directions on a flat sheet. The touch manipulation portion 21 can detect the touch manipulation including touch-on and touch-off of a finger of the user's hand on the manipulation surface and the position (two-dimensional coordinate) of the finger. The detection method may use a resistance film or the capacitance. A finger of the user's hand may be considered as a touch pointer for touch manipulation on the manipulation surface. The touch pointer includes a touch pen as well as the finger.

As in FIG. 2, the touchpad 20 includes a manipulation signal output unit 25 as a signal output device or means. The manipulation signal output unit 25 outputs a manipulation position signal corresponding to the touch manipulation on the touch manipulation portion 21 and manipulation signals corresponding to the manipulation keys 22, 23, and 24 to the controller 4. The embodiment uses a cable for wired connection between the touchpad 20 and the navigation apparatus 2. The connection may use wireless communication such as Bluetooth (registered trade mark).

The user can perform various gesture manipulations including touch-on and touch-off on the touch manipulation portion 21 of the touchpad 20. Similarly to the touch panel 11, the touch manipulation portion 21 enables the user to input various instructions to the navigation apparatus 2 (display apparatus 3). The user's gesture manipulations on the touch manipulation portion 21 include (i) a tap manipulation on a manipulation screen, (ii) a drag manipulation (to move a finger (one finger) touched on the manipulation surface), (iii) a flick manipulation (to quickly move a finger touched on the manipulation surface across the screen), (iv) a pinch-out manipulation (to move two fingers touched on the manipulation surface so that the fingers move apart), and (v) a pinch-in manipulation (to move two fingers touched on the manipulation surface so that the fingers move together).

When the user manipulates the touchpad 20, the manipulation signal output unit 25 outputs (notifies) a manipulation position signal to the controller 4 as above. The manipulation position signal indicates the type of user's gesture manipulation including touch-on and touch-off on the touch manipulation portion 21, a manipulation position (coordinate), a movement direction, or a movement amount. The controller 4 functions as a manipulation determination section, device, or means that determines the user's manipulation based on the manipulation position signal notified from the manipulation signal output unit 25 of the touchpad 20. The controller 4 performs various input setup processes according to the determination. Obviously, there is a correspondence relation between the two-dimensional coordinate of the touch manipulation portion 21 and the two-dimensional coordinate of a screen on the display apparatus 3. The controller 4 also includes a timer function that measures the time (i.e., a time interval to the next manipulation) required for the gesture manipulation.

Suppose that the display apparatus 3 displays a navigation screen image (map display screen image) as in FIG. 4. In this case, the controller 4 performs the following control (manipulation) based on the manipulation on the touchpad 20. The controller 4 performs a coordinate settlement notification concerning the position of tap manipulation on the touch manipulation portion 21. The tap manipulation signifies a sequence of touch-on and touch-off after a lapse of specified time while the touch position hardly moves. The controller 4 performs the manipulation (submit) of icon I where cursor C is positioned at the time.

The drag manipulation on the touch manipulation portion 21 moves cursor C in the movement direction (corresponding to the movement amount). The flick manipulation on the touch manipulation portion 21 scrolls a map screen image on the screen in the flick manipulation direction. The controller 4 performs the coordinate settlement notification corresponding to the position where the touch-off is detected in the flick manipulation. The controller 4 changes the map scale, namely, enlarges (to view the detail) or reduces (to view a wider area) the map when the pinch-out or the pinch-in is performed on the touch manipulation portion 21.

As will be described in detail concerning the description of a behavior (description of a flowchart), the controller 4 according to the embodiment determines whether the flick manipulation or the tap manipulation is performed, based on a movement speed of the touch position from the touch-on to the touch-off when the manipulation signal output unit 25 of the touchpad 20 issues a coordinate settlement notification. More specifically, the controller 4 calculates a movement speed from (i) a movement amount in movement of the touch position from the touch-on to the touch-off and (ii) the time required for the movement. The controller 4 determines the flick manipulation when the movement speed is greater than or equal to a threshold value. The controller 4 determines the tap manipulation when the movement speed is smaller than the threshold value.

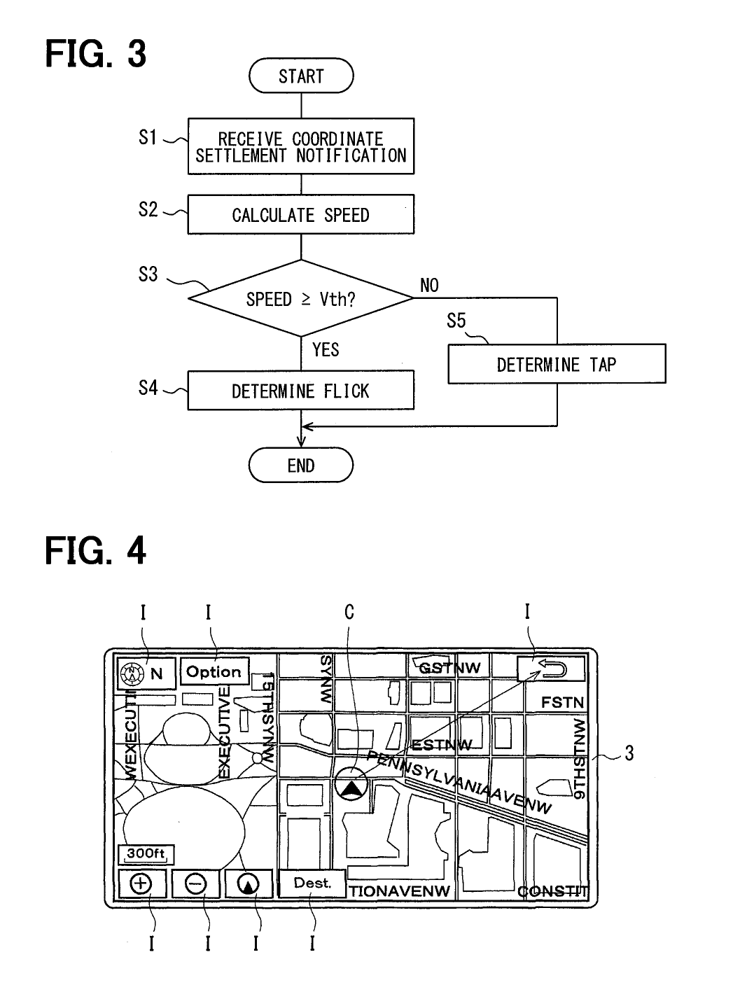

The behavior of the above-mentioned configuration will be described also with reference to FIG. 3. As above, the user (a driver or other occupants) can remotely manipulate the screen on the display apparatus 3 by manipulating the touch manipulation portion 21 of the touchpad 20. The user can select (submit) icon I, scroll a map screen image, or enlarge or reduce the map screen image based on various manipulations on the touch manipulation portion 21 of the touchpad 20.

Various gesture manipulations using the touchpad 20 include the movement manipulation using one finger on the touch manipulation portion 21. This movement manipulation basically moves cursor C. The user's flick manipulation is accompanied by movement of cursor C. Suppose that the position (touch-off) where the user lifts the user's finger corresponds to icon I at the top right of the screen when the flick manipulation on the touch manipulation portion 21 is completed. In such a case, the coordinate settlement notification may cause the tap manipulation to icon I. Namely, the user's manipulation on the touch manipulation portion 21 may be incorrectly determined to cause a manipulation contrary to user's intention.

To solve this, the controller 4 according to the embodiment performs a manipulation determination process according to a flowchart in FIG. 3 when the manipulation signal output unit 25 of the touchpad 20 issues the coordinate settlement notification.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means. Each or any combination of sections explained in the above can be achieved as (i) a software section in combination with a hardware unit (e.g., computer) or (ii) a hardware section, including or not including a function of a related apparatus; furthermore, the hardware section (e.g., integrated circuit, hard-wired logic circuit) may be constructed inside of a microcomputer.

At S1, the controller 4 receives a coordinate settlement notification from the manipulation signal output unit 25 of the touchpad 20. At S2, the controller 4 calculates a movement speed based on: the movement amount from the position of cursor C corresponding to the touch-on to the position (touch-off position) corresponding to the coordinate settlement notification; and the time required from the touch-on to the touch-off.

At S3, the controller 4 determines whether the calculated movement speed is greater than or equal to a threshold value. The calculated movement speed may be greater than or equal to a threshold value (S3: Yes). In this case, the controller 4 proceeds to S4 and determines that the coordinate settlement notification signifies a flick manipulation. The movement speed may be smaller than the threshold value (Vth) (S3: No). In this case, the controller 4 proceeds to S5 and determines that the coordinate settlement notification signifies a map tap manipulation.

Suppose that the user manipulates the touch manipulation portion 21 using user's one finger. The tap manipulation does not move the finger between the touch-on position and the touch-off position and causes very little or no change to the position. In contrast, the move manipulation, where user can move cursor C on the screen, moves the finger from the touch-on position to the touch-off position; in this case, the movement speed of the finger (touch position) is relatively low. Contrastingly, the flick manipulation relatively fast moves the finger after the touch-on and causes the touch-off manipulation to occur in a short period of time.

As above, the controller 4 determines whether the flick manipulation or the tap manipulation is performed, based on a movement speed of the touch position from the touch-on to the touch-off on the touch manipulation portion 21. The controller 4 can thereby fully reliably determine the manipulation the user intended. Thus, the manipulation system 1 according to the embodiment includes the remote manipulation apparatus 20 with the touch manipulation portion 21 and can provide an excellent effect of being able to reliably determine the touch manipulation on the touch manipulation portion 21 and prevent a process contrary to user's intention from being performed.

The embodiment applies the disclosure to control over the display apparatus in the navigation apparatus for vehicles. However, the disclosure is not limited thereto but is also applicable to control over various instruments (manipulation targets). The embodiment has described manipulations of the finger as the touch pointer on the touch pad as the touch manipulation portion. Further, a touch pen may be used as the touch pointer. The remote manipulation apparatus (touch pad) may not include the manipulation switch.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

what is claimed is:

1. A manipulation system comprising:
a main unit with a display apparatus to be manipulated; and
a remote manipulation apparatus that manipulates an input to the display apparatus,
the remote manipulation apparatus including (i) a flat touch manipulation portion and (ii) signal output unit that detects a manipulation position and outputs a manipulation position signal by detecting a user manipulation including touch-on and touch-off on the touch manipulation portion using either a finger or a touch pen,
the main unit including a manipulation determination section that determines a user manipulation based on a manipulation position signal notified from the signal output unit of the remote manipulation apparatus,
wherein the manipulation determination section determines either a flick manipulation or a tap manipulation based on a movement speed of a touch position from the touch-on to the touch-off on the touch manipulation portion under a display state that a portion receiving the flick manipulation and a portion receiving the tap manipulation are simultaneously displayed in a screen of the display apparatus.

2. The manipulation system according to claim 1,
wherein when the manipulation position signal corresponding to the touch-off is notified from the signal output unit, the manipulation determination section
calculates the movement speed from an amount of a movement of the touch position from the touch-on to the touch-off and a time interval required for the movement and
determines the flick manipulation when the movement speed is greater than or equal to a threshold value.

3. The manipulation system according to claim 1,
wherein the main unit includes a map display function that displays a map screen image on the display apparatus.
